(19) United States
(12) Patent Application Publication
(10) Pub. No.: US 2026/0251355 A1
(43) Pub. Date: Aug. 27, 2026

(54) CONCENTRATED SOLAR POWER SYSTEM WITH START-UP RECEIVER

(71) Applicant: Holtec International, Camden, NJ (US)

(72) Inventors: Krishna P. SINGH, Jupiter, FL (US); Indresh Rampall, Cherry Hill, NJ (US); DC Selvakumar, Nagar (IN); Edward Bell, Medford, NJ (US)

(73) Assignee: Holtec International, Camden, NJ (US)

(21) Appl. No.: 19/547,155

(22) Filed: Feb. 23, 2026

Related U.S. Application Data
(60) Provisional application No. 63/761,428, filed on Feb. 21, 2025.

(51) Int. Cl. F24S 50/80; F24S 20/20; F24S 23/70; F24S 30/42; F24S 60/00; H02K 7/18

(52) U.S. Cl. CPC F24S 50/80; F24S 20/20; F24S 23/70; F24S 30/42; F24S 60/00; H02K 7/1823

(57) ABSTRACT

A concentrated solar power system having a solar energy collection subsystem. The solar energy subsystem has tower extending along a tower axis and a first solar energy receiver movably mounted to the tower. The first solar energy receiver is alterable between a first state and a second state while remaining mounted to the tower, and the first solar energy receiver contains a first heat exchange fluid.

### CROSS-REFERENCE TO RELATED APPLICATIONS

The present application claims the benefit of priority to U.S. Provisional Patent No. 63/761,428, filed Feb. 21, 2025, the entirety of which is incorporated by reference.

### BACKGROUND OF THE INVENTION

Thermal energy reaching earth from the sun is quite immense. Yet, harnessing it for useful purposes has been difficult. For over 200 years, fossil fuels excavated from the ground have been the mainstay for energy supply needed to support human civilization. Solar energy, although ubiquitous and visibly strong between the equatorial and subtropical regions of the earth (between the lines of Cancer and Capricorn), drew little attention until the late 20th century when the nexus between the carbon spewed into the environment by burning of fossil fuels and global climate disruption became impossible to ignore. Solar energy generation, long an object of scant scientific work, now has been vaulted into a central area of academic and industrial research.

A concentrated solar power system is one such system that can be used to harness, store, and use solar energy to generate electricity. Such a system typically employs fields of heliostats to reflect solar energy onto solar energy receivers mounted on a tower to heat a heat transfer fluid. Typically, the solar energy receivers are fixed to the tower and cannot be adjusted. If the focus point of the heliostat field needs to be adjusted to a different receiver on the tower, the entire heliostat field needs to be adjusted to account for this change.

After the heat transfer fluid is heated by the solar energy receivers, it is used to heat a working fluid for use in a power generation cycle. The heat transfer fluid typically used in concentrated solar power systems is molten salt due to its high heat capacity and temperature stability. The molten salt circulates in a flow loop between the solar receiver to the heat exchanger or thermal energy storage unit to deliver solar energy to the working fluid for electricity generation, and then back to the solar receiver to absorb more solar energy. However, such salts typically exist at a solid or “frozen” phase at ambient temperatures. Heating such a salt from the frozen state to a molten state is both a time and an energy intensive process that can greatly reduce a concentrated solar power system's operating efficiency.

Thus, a need exists for a concentrated solar power system that can both move the receiver quickly and efficiently to start-up from a “cold” state so that the concentrated solar power system can harness more solar energy for electricity generation without readjusting the entire heliostat field. The present invention solves this problem by having a solar energy receiver that is movably mounted a tower and by employing this movable solar energy receiver in a system that transfers heat to the heat transfer fluid to start-up the concentrated solar power tower from the “cold” state.

### BRIEF SUMMARY

This disclosure relates to concentrated solar power system with a moveable receiver and methods of operating such a system. The inventions described here in addresses the need described above by providing an efficient and effect system and method for moving a receiver on a tower for starting up a concentrated solar power system from a “cold” state.

In one aspect, the invention is a concentrated solar power system having a solar energy collection subsystem. The solar energy subsystem has tower extending along a tower axis and a first solar energy receiver movably mounted to the tower. The first solar energy receiver is alterable between a first state and a second state while remaining mounted to the tower, and the first solar energy receiver contains a first heat exchange fluid.

In another aspect, the invention is a method of operating a concentrated solar power system which has a solar energy collection subsystem. The solar energy collection subsystem includes a tower and a first solar energy receiver movably mounted to the tower. The method includes steps to move the first solar energy receiver relative to the tower to alter the first solar energy receiver from a first state to a second state. The first solar energy receiver includes heat exchange tubes containing a first heat exchange fluid, and the first solar energy receiver is part of a first fluid flow loop through which the first heat exchange fluid flows.

In another aspect, the invention is a concentrated solar power system which includes a solar energy collection subsystem with a first solar energy receiver, a thermal energy storage vessel containing a thermal mass composition operable to store thermal energy, and an electricity generation subsystem configured to convert thermal energy from a working fluid into electricity. A working fluid flow circuit containing the working fluid and configured to circulate the working fluid therethrough, the working fluid flow circuit comprising, in operable fluid cooperation, a first branch, a second branch comprising the electricity generation subsystem, and a first set of heat exchange tubes at least partially embedded in the thermal mass composition. The working fluid flow circuit is configured to be altered so that during a first operating stage of the concentrated solar power system, the first branch and the first set of heat exchange tubes collectively form an auxiliary fluid flow loop configured to receive thermal energy in the working fluid from the first solar energy receiver and transmit thermal energy from the working fluid to the thermal mass composition through the first set of heat exchange tubes. During a second operating stage of the concentrated solar power system, the second branch and the first set of heat exchange tubes collectively form a power generation fluid flow loop, the power generation fluid flow loop configured to receive thermal energy in the working fluid from the thermal mass composition through the first set of heat exchange tubes and transmit thermal energy from the working fluid to the electricity generation subsystem to generate the electricity.

In a further aspect, the invention is a concentrated solar power system which includes a solar energy collection subsystem comprising a first solar energy receiver and second solar energy receiver, a thermal energy storage vessel containing a thermal mass composition operable to store thermal energy, a first fluid flow loop comprising the first solar energy receiver and containing a first heat exchange fluid, a second fluid flow loop comprising the second solar energy receiver and containing a second heat exchange fluid. During a first operating stage of the concentrated solar power system, the concentrated solar power system is configured to: (i) transmit thermal energy into the first heat exchange fluid via the first solar energy receiver; (ii) transmit thermal energy from the first heat exchange fluid to the thermal mass composition, and (iii) transmit thermal energy from the thermal mass composition to the second heat exchange fluid. Further, at ambient conditions, the first heat exchange fluid has a first viscosity and the second heat exchange fluid has a second viscosity, the second viscosity being greater than the first viscosity.

In another aspect, the invention is a method of operating a concentrated solar power system having a solar energy collection subsystem comprising a first solar energy receiver, a thermal energy storage vessel containing a thermal mass composition operable to store thermal energy, an electricity generation subsystem configured to convert thermal energy from a working fluid into electricity. The method has the following steps. In the first step, during a first operating stage of the concentrated solar power system, heating the working fluid with thermal energy harnessed by the first solar energy receiver, and transmitting thermal energy from the working fluid to the thermal mass composition. In the second step, during a second operating stage of the concentrated solar power system, transmitting thermal energy from the thermal mass composition into the working fluid, and generating electricity utilizing thermal energy from the working fluid with the electricity generation subsystem.

In a further aspect, the invention is a method of operating a concentrated solar power system including a solar energy collection subsystem having a first solar energy receiver and second solar energy receiver, a thermal energy storage vessel containing a thermal mass composition operable to store thermal energy, an electricity generation subsystem configured to convert thermal energy from a working fluid into electricity, a first fluid flow loop comprising the first solar energy receiver and containing a first heat exchange fluid, a second fluid flow loop comprising the second solar energy receiver and containing a second heat exchange fluid. The method has several steps. In the first step, during a first operating stage of the concentrated solar power system, heating the first heat exchange fluid with thermal energy harnessed by the first solar energy receiver, transmitting thermal energy from the first heat exchange fluid to the thermal mass composition, and transmitting thermal energy from the thermal mass composition to the second heat exchange fluid. Further, at ambient conditions, the first heat exchange fluid has a first viscosity and the second heat exchange fluid has a second viscosity, the second viscosity being greater than the first viscosity.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

All drawings are schematic and not necessarily to scale. Parts given a reference numerical designation in one figure may be considered to be the same parts where they appear in other figures without a numerical designation for brevity unless specifically labeled with a different part number and described herein. Any reference herein to a whole figure number herein which may comprise multiple figures with the same whole number but different alphabetical suffixes shall be construed to be a general reference to all those figures sharing the same whole number, unless otherwise indicated.

The features of the exemplary embodiments of the present invention will be described with reference to the following drawings, where like elements are labeled similarly, and in which:

FIG. 1A is a schematic flow diagram of a concentrated solar power system in a first state;

FIG. 1B is a schematic flow diagram of the concentrated solar power system shown in FIG. 1A in a second state;

FIG. 2 is a perspective view of a first solar energy receiver of a solar energy collection subsystem of the concentrated solar power system shown in FIGS. 1A-1B;

FIG. 3 is a perspective view of the solar energy collection subsystem of the concentrated solar power system of FIGS. 1A-1B in the first state;

FIG. 4 is a perspective view of the solar energy collection subsystem of FIG. 3 in the second;

FIG. 5 is a top view of the solar energy collection subsystem of FIG. 3;

FIG. 6 is a top view of the solar energy collection subsystem of FIG. 4;

FIG. 7 is a perspective view of a first alternative embodiment of the solar energy collection subsystem of the concentrated solar power system of FIGS. 1A-1B in the first state;

FIG. 8 is a perspective view of the first alternative embodiment of the solar energy collection subsystem of FIG. 6 in the second state;

FIG. 9 is a top view of the solar energy collection subsystem of FIG. 7;

FIG. 10 is a top view of the solar energy collection subsystem of FIG. 8;

FIG. 11 is a perspective view of a second alternative embodiment of the solar energy collection subsystem of the concentrated solar power system of FIGS. 1A-1B in the first state;

FIG. 12 is a perspective view of the second alternative embodiment of the solar energy collection subsystem of FIG. 10 in the second state;

FIG. 13; is a schematic flow diagram of a first alternate embodiment of a concentrated solar power system; and

FIG. 14 is a schematic flow diagram of a second alternate embodiment of a concentrated solar power system.

### DETAILED DESCRIPTION

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or

orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

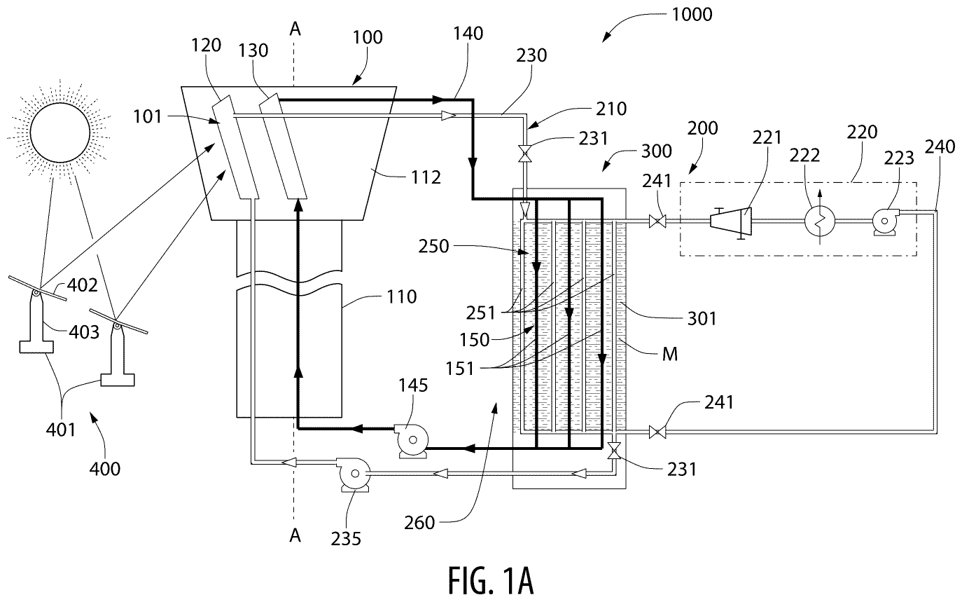

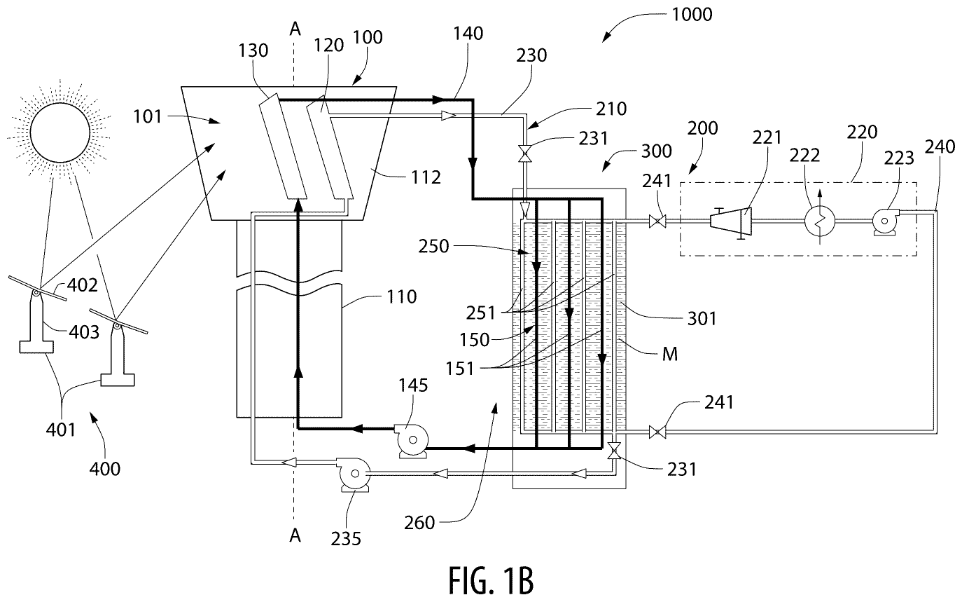

FIGS. 1A & 1B show a schematic flow diagram of a concentrated solar power system 1000. In the exemplified embodiments, the concentrated solar power system 1000 may comprise a solar energy collection subsystem 100. In other embodiments, the concentrated solar power system 1000 may also comprise a working fluid flow circuit 200 and a thermal energy storage vessel 300. The solar energy collection subsystem 100, working fluid flow circuit 200, and the thermal energy storage vessel 300 are all fluidly interconnected with one another via suitable fluid conduits or piping. The solar energy collection subsystem 100, the working fluid flow circuit 200, and thermal energy storage subsystem 300 may be integrated and geographically proximal to one another so that the concentrated solar power system 1000 is a single facility or they may be geographically separated such that the concentrated solar power system 1000 is comprised of multiple sub facilities that are fluidly interconnected. The individual subsystem's structure and function within the concentrated solar power system 1000 are each described in further detail below.

FIGS. 1A & 1B illustrate the concentrated solar power system 1000 according to a first exemplary embodiment. The solar energy collection subsystem 100 of the concentrated solar power system 1000 may comprise a tower 110 that extends along a tower axis A-A and a first solar receiver 120 mounted on the tower 110. The first solar receiver 120 contains a first heat exchange fluid which is operable to absorb solar energy. The tower 110 may be a solar power tower configured to support the first solar energy receiver 120 and the second solar energy receiver 130 which are configured to absorb solar energy reflected on to it from a plurality of heliostats 400. The tower 110 may be a tall, hollow prismatic shell (with an enlarged section near the top, if necessary). The tower 110 may be cylindrical with circular cross-section or a rectangular cuboid with rectilinear cross-section in shape. Other polygonal or non-polygonal shapes of Power Towers may be used and is not limiting of the invention.

The plurality of heliostats 400 comprise individual heliostats 401 that each comprise a reflector 402 mounted on a support frame 403 that rests on the ground. The support frame 403 is configured to angle and adjust the reflector 402 to capture and reflect incident solar energy as sunlight. The reflectors 402 in one embodiment may each be formed by a concave mirror with a radius of curvature or as a flat plate as shown in the exemplified embodiment in FIGS. 1A & 1B. The reflectors 402 are further configured to reflect solar energy onto at least the first solar receiver 120 of the tower 110. The plurality of heliostats 400 may be arranged in a heliostat field that partially or fully surrounds the tower 110. This heliostat field may be roughly circular or semi-circular in shape.

Although not shown in FIGS. 1A & 1B, in some embodiments of the concentrated solar power system 1000 is a hybrid solar energy system which generally includes a combination of the solar energy collection subsystem 100, the plurality of heliostats 400, and a photovoltaic (PV) solar energy system which are thermally and operably coupled to a power generation system in one embodiment for generating electricity. The photovoltaic system may include a plurality of photovoltaic cells that are positioned adjacent or surrounding the plurality of heliostats 400. The photovoltaic cells may be operably coupled to an electric heater which is operably coupled to the working fluid circuit 200.

The first solar receiver energy 120 may be the only solar energy receiver mounted on the tower 110, but the invention is not limited to just this arrangement. The solar energy collection subsystem 100 may comprise a second solar energy receiver 130, or the solar energy collection may comprise a plurality of solar energy receivers. In embodiments where the solar energy collection subsystem 100 comprises a second solar energy receiver 130, the second solar energy receiver 130 contains a second heat exchange fluid which is operable to store thermal energy. In the exemplified embodiment, the first heat exchange fluid and the second heat exchange fluid are different from one another, but they may be the same fluid in other embodiments. Further details on the composition of the first heat exchange fluid and the second heat exchange fluid are provided below.

The first heat exchange fluid and the second heat exchange fluid are both configured to absorb solar energy while they are contained within the respective first solar energy receiver 120 and the second solar energy receiver 130. The first heat exchange fluid and the second heat exchange fluid are also configured to store that solar energy as thermal energy. Various fluids may be used as the first heat exchange fluid and the second heat exchange fluid including synthetic heat transfer oil, molten salt, water, air, supercritical carbon dioxide, helium, nitrogen, or another fluid suitable for high temperature heat transfer. The synthetic heat transfer oil may be, without limitation, DOWTHERM™ available from Dow Chemical Inc. In the exemplified embodiment shown in FIGS. 1A & 1B the first heat exchange fluid, at ambient conditions, has a first viscosity and the second heat exchange fluid has a second viscosity, the second viscosity being greater than the first viscosity. Preferably, the first heat exchanger fluid in the concentrated solar power system 1000 is water and the second heat exchange fluid is molten salt. As discussed in further detail below, the first heat exchange fluid may also serve as a working fluid suitable for driving a power generation cycle such as a Rakine cycle.

The first solar receiver 120 may be mounted at a target location 101 on an upper portion 112 of the tower 110. This target location 101 is positioned at or approximate to the focal point where solar energy is reflected by the plurality of heliostats 400. In embodiments where the solar energy collection subsystem 100 comprises the second solar energy receiver 130, the second solar energy receiver may also be mounted on the upper power portion 112 of the tower proximate to the target location 101. In the exemplified embodiment, the second solar energy receiver 130 is mounted at the same elevation as the first solar energy receiver. However, in other embodiments, the second solar energy receiver 130 may be mounted at a higher elevation or at a lower elevation than the first solar energy receiver 120 depending on the arrangement of the plurality of heliostats 400.

In the exemplary embodiment of the concentrated solar power system 1000 shown in FIGS. 1A & 1B, the first solar energy receiver 120 may be mounted on the tower 110 so that it is alterable between a first state and a second state while remaining mounted to the tower. FIG. 1A illustrates the first state which may be described as an “operating” state. In this first state, the first solar energy receiver 120 is positioned in a first position to receive at least a portion of the reflected solar energy from the plurality of heliostats 400 to heat the first heat exchange fluid in the first solar energy receiver 120. If the second solar receiver 130 is included, the first solar energy receiver 130 at least partially blocks the reflected solar energy from reaching the second solar energy receiver 130. FIG. 1B illustrates the second state which may be described as “standby” state. In this second state, the first solar energy receiver 120 is moved to a second position that is different from the first position. If the second solar energy receiver 130 is present, the first solar receiver 120 is positioned so as to not block the reflected solar energy from reaching the second solar energy receiver 130 or blocks a lesser amount of the reflected solar energy from reaching the second solar energy 130 receiver.

The first solar energy receiver 120 may alterably transition between the first state to the second state and then from the second state to the first state. This transition may be triggered automatically through the use of an automatic controller. For instance, the first solar energy receiver 120 may transition from the second state to the first state in the early morning hours to direct sunlight to the first solar energy receiver 120 and then transition from the first state to the second state as the sun rises higher in the sky so that the second solar energy receiver 130 receives solar energy from the plurality of heliostats 400. The concentrated solar power system 1000 may physically transition the first solar energy receiver 120 from the first state to the second state in various ways which will be described in further detail below.

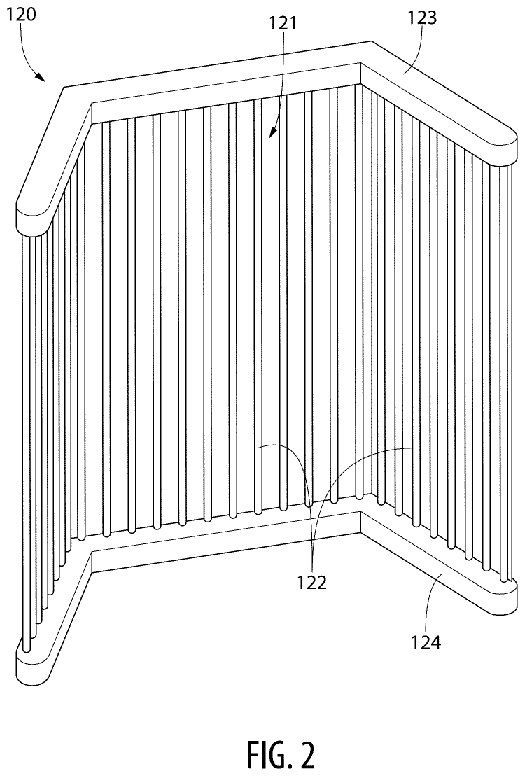

Referring to FIG. 2, the first solar energy receiver 120 is shown schematically. The exemplified embodiment shown in FIG. 2 shows the first solar energy receiver 120 with straight three sections. However, in other embodiments the first solar energy receiver 120 may also have an overall curved shape so that a convex side faces the plurality of heliostats 400 and a concave side that faces away from the plurality of heliostats. In other embodiments this arrangement may be reversed and the concave side may face the plurality heliostats 400 and the convex side may face away from the plurality heliostats 400. The first solar energy receiver 120 may also take one more complex shapes as well such as having an overall curved shape but with undulations along its curvature.

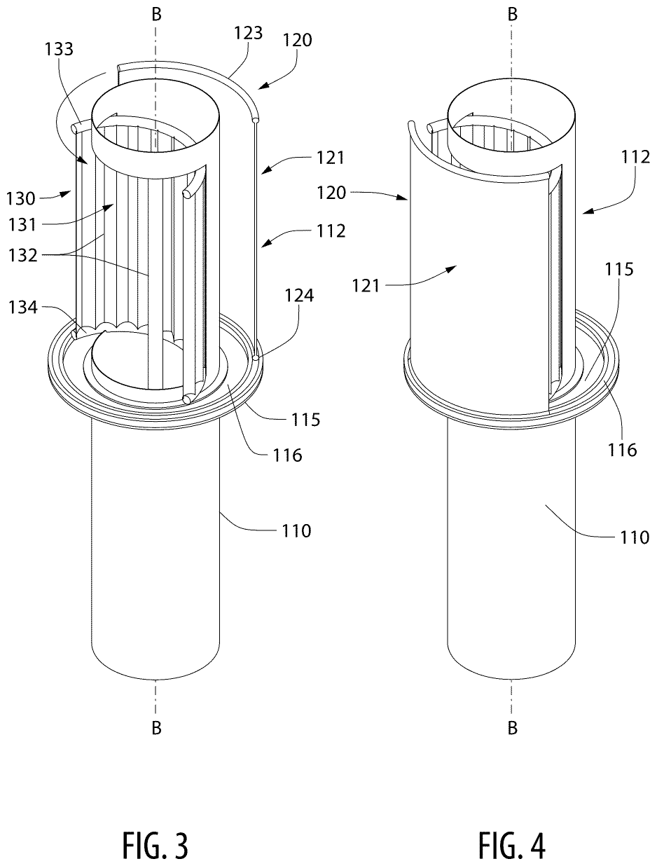

In the exemplified embodiment, the first solar energy receiver 120 comprises a first receiver tube bundle 121 comprising first receiver heat exchange tubes 122. The first receiver tube bundle 121 is coupled between a first upper manifold 123 and a first lower manifold 124. The plurality of heliostats 400 may be angled so that solar energy is reflected on to or proximal to the first receiver tube bundle 121. The first receiver tube bundle 121, first upper manifold 123, and first lower manifold 124 are all fluidly interconnected so that a first heat exchange fluid can flow from the lower manifold 124, rise through the tube bundle 121, and collect in the upper manifold 123. Solar energy reflected by the plurality of heliostats 400 heats this first heat exchange fluid within the tube bundle 121. As show in FIGS. 3-6, the second solar energy receiver 130 is similarly structured to the first solar energy receiver 120 and may comprise a second tube bundle 131 comprising second receiver heat exchange tubes 132. The tube bundle 131 is coupled between a second upper manifold 133 and a second lower manifold 134. The function of second tube bundle 131, the second upper manifold 133, and the second lower manifold 134 within the second solar energy receiver 130 is the same as the function of the first tube bundle 121, the first upper manifold 123, and the first lower manifold 124 described above.

For both the first solar energy receiver 120 and the second solar energy receiver 130, The receiver tube surface of the first receiver heat exchange tubes 122 and the second receiver heat exchange tubes 132 which face the plurality of heliostats 400 may be coated with a material that has high absorptivity in the solar wavelength range, but a low emissivity in the infrared wavelength range. The first solar energy receiver 120, the second solar energy receiver 130, and any other solar energy receivers mounted on the tower 110 may be arranged in a circumferential array adjacent to each other to receive the reflected and concentrated solar energy or radiation (i.e. light) flux from the plurality of heliostats 400 for a full 360 degrees of the heliostat field for low latitude areas of the world. For high latitudes, the receivers are designed to receive the concentrated radiation flux from the north side of the tower 110 in the northern hemisphere and from the south side of the tower in the southern hemisphere. Accordingly, a number of variations are possible to adjust to and maximize the solar site conditions and location.

FIGS. 3-6 illustrate a first embodiment of solar energy collection subsystem 100 which comprises the first solar energy receiver 120 and the second solar energy receiver 130 where the first solar energy receiver 120 is movably altered rotationally. As shown in FIGS. 2-3, the first solar energy receiver 120 is mounted to the tower 110 to be pivotable between the first state and the second state about at least one pivot axis B-B. In the exemplified embodiment, the pivot axis B-B is parallel with the tower axis A-A and may be coaxial with the tower axis A-A. The first solar energy receiver 120 pivots about the first pivot axis B-B while the second solar energy receiver 130 is fixedly mounted on the tower 110.

In this embodiment, the first solar energy receiver 120 is mounted on a track 115 as shown in FIGS. 3-6 which may be fixedly coupled to the tower 110 on a flange 116. The first solar energy receiver 120 is arcuately curved to fit within this track 115. Alternatively, the first solar energy receiver 120 may be equipped with a plurality of rollers or wheels which rollingly engage the arcuately curved track surface on the tower 110 such as provided by a curved metal flange. The track 115 may be flat or include a channel which receives the wheels.

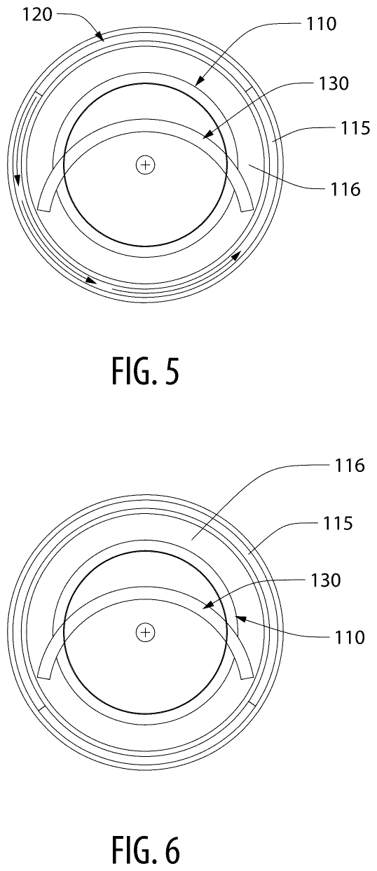

In either embodiment, a suitable drive mechanism operably coupled to the first solar energy receiver 120 may be used to impart the rotational motion to the first solar energy receive 120. The drive mechanism in one embodiment may comprise an electric drive motor operably coupled to the first solar energy receiver 120. As shown in FIGS. 5-6, the drive motor and/or its control circuit may be configured to rotate the first solar energy receiver 120 at least 180 degrees in forward and reverse directions to selectively assume with standby or operating states. Other embodiments may include a toothed gear track which is operably engaged by a rotating toothed drive gear coupled to a motor shaft for imparting rotary motion to the first solar energy receiver 120.

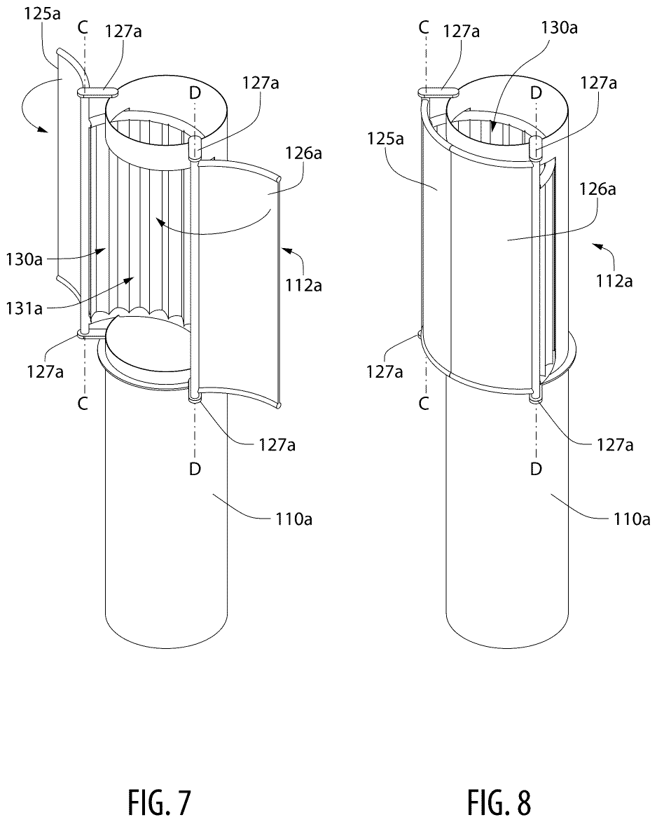

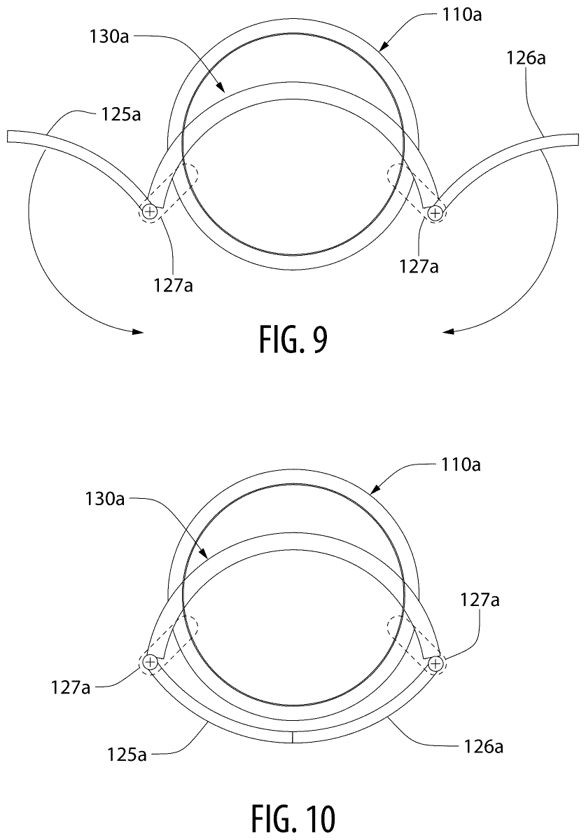

FIGS. 7-10 illustrate a second embodiment of solar energy collection subsystem 100a which comprises a first solar energy receiver 120a and a second solar energy receiver 130a. Unless otherwise noted, the subcomponents and subsystems of this second embodiment of the solar energy collection subsystem 100a share the same subcomponents and subsystems of the solar energy collection subsystem 100 but are referred using “a” reference signs.

In the embodiment shown in FIGS. 6-9, the first solar energy receiver 120a comprises a first sub-receiver 125a and a second sub-receiver 126a. The first sub-receiver 125a is mounted to the tower 110a to be pivotable between a second pivot axis C-C and the second sub-receiver 126a is mounted to the tower 110a to be pivotable about a third pivot axis D-D. The second solar energy receiver 130a is located between the second pivot axis C-C and the third pivot axis D-D. In the exemplified embodiment, the first sub-receiver 125a and the second sub-receiver 126a are hingedly mounted on sub-receiver supports 127a on opposing sides of the second solar energy receiver 130a. The first sub-receiver 125a and the second sub-receiver 126a perform and operate similarly to hinge-mounted window shutters. In the exemplified embodiment, the second pivot axis C-C and the third pivot axis D-D are parallel with one another.

The first sub-receiver 125a and the second sub-receiver 126a are pivotably movable in a horizontal direction between (1) a folded standby state extending rearwards on each side of the second solar energy receiver 130a to expose the second receiver tube bundle 132a on a concave side of the second solar energy receiver 130a to the reflected sunlight from the heliostat array 400a, and (2) an unfolded operating state extending forward and inward spanning across the front of the second solar energy receiver 130 to block the reflected sunlight from reaching the second receiver tube bundle 132a. The first sub-receiver 125a and the second sub-receiver 126a are movable towards each other to the folded position, and away from each other towards the unfolded position.

In another similar alternative embodiment, the first solar energy receiver 120a may instead comprise a single wider tubed receiver panel in lieu of a first sub-receiver 125a and a second sub-receiver 126a. The panel is hingedly mounted on tower 110a on one or the other side of the second solar energy receiver 130a and operable to be rotated about a vertical pivot axis between the second and first states. The arrangement would be similar to that shown in FIGS. 6-9 for one of either the first sub-receiver 125a or the second sub-receiver 126a if either were made wider to at least partially block the sunlight reflected from the plurality of heliostats 400a from reaching the second solar energy receiver 130a when the wider tubed panel receiver is in the second state.

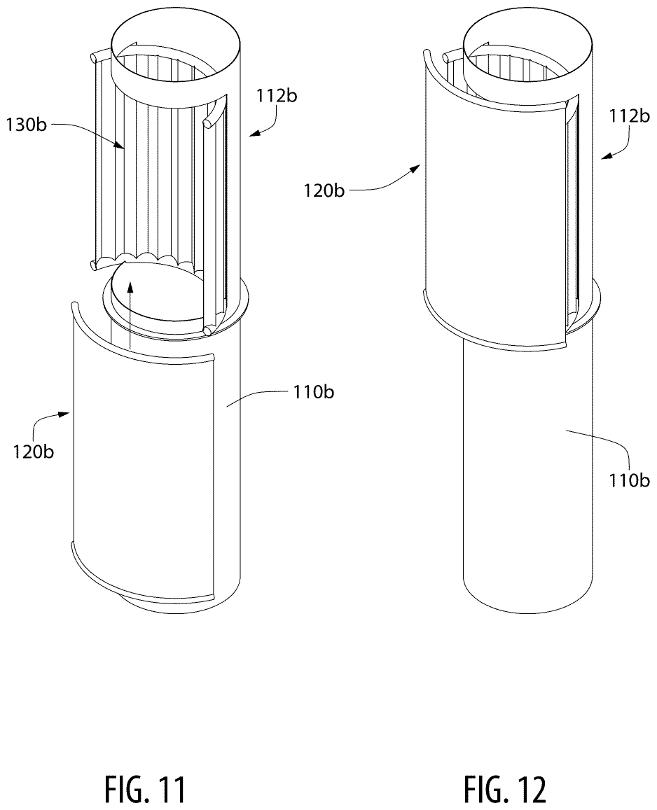

FIGS. 11-12 illustrate a third embodiment of solar energy collection subsystem 100b which comprises the first receiver solar energy receiver 120b and a second solar energy receiver 130b. Unless otherwise noted, the subcomponents and subsystems of this third embodiment of the solar energy collection subsystem 100b share the same subcomponents and subsystems of the solar energy collection subsystem 100 but are referred using “b” reference signs.

In the embodiment illustrated in FIGS. 11-12, a first solar energy receiver 120b is mounted below a second solar energy receiver 130b on a tower 110b when in second state. When needed, the first solar energy receiver 120b may be linearly moved upwards on the tower 110b to its first state in front of the second solar energy receiver 130b. In such an embodiment, the first solar energy receiver 120b may be below its position in the first state when it is in the second state as shown. Alternatively, the first solar energy receiver 120b may be above its position in the first state when it is in the second state. A motor-operated chain drive or linear actuators may be used to move the first solar energy receiver 120b vertically between the first state and second state. The first solar energy receiver 120b in such an embodiment may be straight or arcuately curved in configuration.

Referring back to FIGS. 1A & 1B, the concentrated solar power system 1000 may further comprise a first fluid flow loop 210 configured to flow the first heat exchange fluid therethrough. In the exemplified embodiment, this flow is driven by a fluid flow pump 235. The first solar energy receiver 120 may be part of the first fluid flow loop 210. In embodiments that include the second solar energy receiver 130, the concentrated solar power system 1000 may further comprise a second fluid flow loop 140 which is configured to circulate the second heat exchange fluid therethrough. In the exemplified embodiment, this flow is driven a second flow pump 145. In such embodiments, the second solar energy receiver 130 forms part of the second fluid flow loop 140. The concentrated solar power system 1000 is further configured to transfer thermal energy from the first heat exchange fluid in the first fluid flow loop 210 to the second heat exchange fluid in the second fluid flow loop 140 when the first solar energy receiver is in the first state. In such an instance, the first state is a startup operation stage and the lower viscosity first heat exchange fluid is transferring thermal energy to the higher viscosity second heat exchange fluid. Details on the applicability of this function will be further described below with reference to the working fluid circuit 200 and the thermal energy storage system 300.

The working fluid circuit 200 of the concentrated solar power system 1000 is fluidly interconnected with the solar energy collection subsystem 100 and is configured to circulate a working fluid. The working fluid circuit 200 comprises an electricity generation subsystem 220 which is configured to convert thermal energy from the working fluid into electricity. To this end, the electricity generation subsystem 220 may comprise a turbine 221, and a generator 222 operably coupled to the turbine and an electricity generator subsystem pump 223 which drives the working fluid through the working fluid circuit 200. In the exemplified embodiments of FIGS. 1A & 1B, the first heat exchange fluid is also the working fluid and is water in the form of steam. The working fluid circuit 200 is thus configured to heat the working fluid so that it transitions into steam and the electricity generation subsystem 220 is configured to convert the thermal energy from the steam into electricity by spinning the turbine 221 to operate the generator 222 via a Rankine power cycle. If another fluid heat exchange fluid is used as the working fluid, another power cycle may be employed to convert the thermal energy stored in the working fluid into electricity. For instance, if air or super critical carbon dioxide are used as the working fluid, a Brayton power cycle may be employed.

In the exemplified embodiment of the concentrated solar power system 1000 of FIGS. 1A & 1B, the working fluid circuit 200 comprises the first fluid flow loop 210. In this embodiment, the first fluid flow loop 210 comprises a startup branch 230 which includes the first solar energy receiver 120. The startup branch 230 may also be referred to as first branch of the working fluid circuit 200. The first flow pump 235 may be part of the startup branch of the working fluid circuit 200. The working fluid circuit 200 may further comprise a power generation branch 240 that includes the electricity generation subsystem 220. The power generation branch 240 may also be referred to as a second branch. In such an embodiment, the working fluid circuit 200 is configured to isolate the startup branch 230 from a first remainder of the working fluid circuit 200 to prevent flow of the working fluid through the startup branch 230 during a power generation stage of the concentrated solar power system 1000. This is accomplished by opening and closing startup branch valves 231. The startup branch valves 231 may be any isolation valve suitable for operating in a high temperature fluid loop.

The concentrated solar power generation system 1000 may also be configured to isolate the power generation branch 240 from a remainder of the working circuit 200 to prevent flow of the working fluid through the power generation branch 240 during the startup operating stage. This is accomplished by opening and closing power generation branch valves 241. As with the startup branch valves 231, the power generation valves 241 may any isolation valves suitable for operating in a high temperature fluid loop. More specifically, the isolation valves used may be gate valves or ball valves. Although not illustrated in FIGS. 1A & 1B, the startup branch valves 231 and the power generation valves 241 may be actuated via a controller. This controller may receive signals from sensors included throughout the concentrated solar power system 1000 is inoperable to actuate the startup branch valves 231 and the power generation valves 211 based on the signals received from those sensors. The sensors may be temperature sensors, pressure sensors, vibration sensors, flow sensors, or any other type of sensor used to monitor power generation systems.

In the exemplified embodiment, the concentrated solar power generation system 1000 operates in the power generation stage when the first solar energy receiver 120 is in the second state to allow the second solar energy receiver 130 to heat the working fluid. Of course, in other embodiments, the solar power generation system 1000 operates in the power generation stage when the first solar energy receiver 120 is in the first state. Further, when concentrated solar power generation system 1000 is operating in the power generation stage, the working fluid flow circuit 200 comprises a power generation fluid flow loop 245 which includes the electricity generation subsystem 220. The operation of this power generation fluid flow loop 245 will be further detailed below.

The thermal energy storage vessel 300 of the exemplified concentrated solar power generation system 1000 will now be described in greater detail. The thermal energy storage vessel 300 is fluidly interconnected with the both the solar energy collection subsystem 100 and the working fluid circuit 200 and contains a thermal mass composition M within an internal cavity 301. Thermal energy storage vessel 300 may have an overall cylindrical shape. Alternatively, the thermal energy storage vessel 300 may be a rectangular cuboid configuration. In the exemplified embodiment shown in the FIGS. 1A & 1B, the thermal energy storage vessel 300 is shown as a single unit. However, in alternate embodiments, the thermal energy storage vessel 300 may be comprised of several separate modules that can either be fluidly isolated or fluidly coupled together.

The thermal mass composition M contained within the internal cavity 301 of the thermal energy storage vessel is operable to store thermal energy and is a high heat retention capacity granular particulate mass forming a continuum of particles which fills the internal cavity 301 of the thermal energy storage vessel 300.

Thermal mass composition M will now be further described.

Any suitable thermal mass composition M may be used which can be customized and selected for the required thermal duty and operating parameters needed for heating the second heat transfer fluid and the working fluid from an inlet temperature entering the thermal energy storage vessel 300 to a desired outlet temperature. In the exemplified embodiment, thermal mass composition M comprises a mixture that includes a phase change material (“PCM”) in combination with one or more metallic materials. Both the PCM and metallic materials of the mixture may be in the form of solid granular particles at ambient temperatures when not heated by the thermal mass composition M. The PCM material preferably has a lower melting temperature than the metallic materials in one embodiment such that PCM material melts when initially heated by the first working fluid (e.g., molten salt or heat transfer oil) while the metallic materials remain in a solid particle state. Both the base metallic material(s) and PCM are materials having properties configured to produce a thermal mass operable to absorb and store heat, and release that heat on demand when required to heat the second heat transfer fluid and the working fluid flowing through the thermal energy storage vessel 300.

Preferably, the at least one base metallic material may constitute a majority of the mixture or composition and has a higher melting point or temperature Tbm than the melting point or temperature Tpcm of the PCM. Temperature Tpcm is preferably lower than the normal operating temperature Tnm of the thermal mass composition M to which the mass will be heated for normal operation such that the PCM melts and changes to a liquid or molten state when the thermal mass is heated. At ambient temperatures, the PCM is in a solid particle state.

By contrast, the at least one base metallic material preferably has a melting temperature Tbm greater than the normal operating temperature Tmm, and preferably greater than the maximum temperature Tmax of the thermal mass composition M such that the base metallic material always remains in a solid particle state when thermal energy is added to the thermal mass composition. In some representative but non-limiting examples, the base metallic material may have a melting temperature Tbm greater than 1,000 degrees C. (Celsius), or greater than 2,000 degrees C. in some embodiment, whereas the PCM may have a melting temperature Tpcm less than 1,000 degrees C. The metallic material may comprise a single one or a combination of ferrous and/or non-ferrous metal particles selected to optimize heat retention capabilities and meeting the foregoing melting temperature criteria.

In preferred but non-limiting embodiments, the PCM used may be a salt which may be converted from a granular solid particle state at ambient temperatures to a liquid/molten state when heated. Any suitable salt may be used which is selected for the required thermal duty.

Some examples of salts which may be used to form the PCM in each thermal energy storage vessel 300 are shown in the following table:

| Tₘₑₗₜ | | Latent Heat |
|---|---|---|
| (° C.) | Material | (kJ/kg) |
| 94 | 60 wt % AlCl₃ + 14% KCl + 26% NaCl | 213 |
| 150 | 66 wt % AlCl₃ + 34% NaCl | 201 |
| 202 | 7.5 wt % NaCl + 23.9% KCl + 68.6% ZnCl₂ | 200 |
| 258 | 59 wt % NaOH + 41% NaNO₃ | 292 |
| 307 | NaNO₃ | 177 |
| 318 | 77.2 mol % NaOH -16.2% NaCl - 6.6% Na₂CO₃ | 290 |
| 320 | 54.2 mol % LiCl - 6.4% BaCl₂ - 39.4% KCl | 170 |
| 335 | KNO₃ | 88 |
| 340 | 52 wt % Zn - 48% Mg | 180 |
| 348 | 58 mol % LiCl - 42% KCl | 170 |
| 370 | 26.8% NaCl - 73.2% NaOH | 320 |
| 380 | KOH | 149.7 |
| 380 | 45.4 mol % MgCl₂ - 21.6% KCl - 33% NaCl | 284 |
| 381 | 96 wt % Zn - 4% Al | 138 |
| 397 | 37 wt % Na₂CO₃ - 35% K₂CO₃ - 31% Li₂CO₃ | 275 |
| 430 | 56 wt % NaCl - 44% MgCl₂ | 168 |
| 443 | 59 wt % Al - 35% Mg - 6% Zn | 310 |
| 450 | 48 wt % NaCl - 52% MgCl₂ | 430 |
| 470 | 36 wt % KCl - 64% MgCl₂ | 388 |
| 487 | 56 wt % Na₂CO₃ - 44% Li₂CO₃ | 368 |
| 500 | 33 wt % NaCl - 67% CaCl₂ | 281 |
| 550 | LiBr | 203 |
| 632 | 46 wt % LiF - 44% NaF₂ - 10% MgF₂ | 858 |
| 658 | 44.5 wt % NaCl - 55.5% KCI | 388 |
| 714 | MgCl₂ | 452 |
| 801 | NaCl | 510 |

The melt temperatures and latent heat properties of the salt are properties and factors which direct the selection of the type salt for the required thermal duty and temperature increase of the heat transfer fluid. It bears noting that the type of salt used in each thermal energy storage vessel 130 for the Green Boiler 120 may therefore be customized and different. Regardless of the application including simply heating water for district heating or other applications, it is apparent to those skilled in the art that thermal duty and performance of the thermal energy storage vessel 121 is highly customizable to meet the required temperature increase objectives of the thermal energy system.

It bears noting that any suitable PCM may be used other than the salts such as those listed above may be used so long as the melting temperature Tpcm of the PCM is less than the normal operating temperature Tnm (previously described herein) of the thermal mass composition during operation of the thermal energy storage vessel 300.

The concentrated solar power generation system 1000 may comprise a thermal energy storage tube bundle 250 comprising a first set of heat exchange tubes 251 at least partially embedded in the thermal mass composition M and a second thermal energy storage tube bundle 150 comprising a second set of heat exchange tubes 151 embedded at least partially in the thermal mass composition M. The first set of heat exchange tubes 251 are spaced apart from the second set of heat exchange tubes 151 such that the thermal mass composition M is entirely between the first set of heat exchange tubes 251 and the second set of heat exchange tubes 151. The first tube bundle 250 and the second tube bundle 150 each comprise inlet and outlet headers that are fluidly interconnected with the first set of heat exchange tubes 251 and the second set of heat exchange tubes 151 that allow fluid to flow into and out of the first set of heat exchange tubes 251 and the second set of heat exchange tubes respectively.

In some embodiments, the first set of heat exchange tubes 251 of the first tube bundle 250 may form a part of the working fluid flow circuit 200 and the second set of heat exchange tubes 151 of the second tube bundle 150 may form a part of the second fluid flow loop. In this arrangement, the concentrated solar power system 1000 is configured such that, during the startup operating stage, the working fluid is heated by the first solar energy receiver 120, the thermal mass composition M is heated by the working fluid, and then the thermal mass composition heat the second heat exchange fluid within the second fluid flow loop 140. Conversely, during the power generation operating stage, the concentrated solar power system 1000 is so that during the power generation operating stage, the second heat exchange fluid is heated by the second solar energy receiver, the second heat exchange fluid heats the thermal mass composition, the thermal mass composition heats the working fluid. Further details on how the concentrated solar power system 1000 is configured to operate in this manner are discussed below.

Referring specifically to FIG. 1A, some embodiments of the concentrated solar power system 1000, the startup branch 230, also referred to as the first branch, of the working fluid circuit 200 and the first heat exchange tubes 251 of the first thermal energy storage tube bundle 250 form an auxiliary fluid flow loop 260 during a first operating stage of the concentrated solar power system 1000. This auxiliary flow loop 260 is configured to receive thermal energy in the working fluid from the first solar energy receiver 120 and transmit thermal energy from the working fluid to the thermal mass composition M through the first set of heat exchange tubes 251. This stores the thermal energy within the thermal mass composition M either to heat the second working fluid within the second plurality of tubes 151 or for reheating the working fluid within the first set of heat exchange tubes 251 for later use. The power generation valves 210 may be closed while the auxiliary fluid flow loop 260 is formed. Alternatively, they may be opened to allow the working fluid to also flow through the electricity generating subsystem 220. This may advantageously transfer thermal energy to the electricity generating subsystem 220 as well as the thermal mass composition M.

Referring specifically to FIG. 1B, the power generation branch 240, also referred to as the second branch, of the working fluid circuit 200 and the first set of heat exchange tubes 251 collectively form a power generation fluid flow loop 270 during a second operating stage. The power generation fluid flow loop 270 is configured to receive thermal energy in the working fluid from the thermal mass composition M through the first set of heat exchange tubes 251 and transmit thermal energy from the working fluid to the electricity generation subsystem 220 to generate the electricity. The startup branch valves 231 are closed during the second operating stage to prevent working fluid from flowing through the second branch.

A method for operating the concentrated solar power system 1000 will now be described. The order of each of the recited steps is not limited to the order recited herein and each step may be performed either immediately after one another or after a certain about of time.

The method may include a step a) for moving the first solar energy receiver 120 relative to the tower 110 to alter the first solar energy receiver 120 from the first state to the second state. For this method, the first state is the startup operating state in which the first solar energy receiver 120 is positioned to receive at least a portion of reflected solar energy from the plurality of heliostats 400 to heat the first heat exchange fluid via the heat exchange tubes of the first solar energy receiver and at least partially block the reflected solar energy from reaching the second solar energy receiver 130. The second state is a standby state in which the first solar energy receiver 120 is positioned so as to not block the reflected solar energy from reaching the second solar energy receiver 130 or blocks a lesser amount of the reflected solar energy from reaching the second solar energy receiver 130.

In some embodiments, when the first solar energy receiver 120 is in the first state, the concentrated solar power system 1000 is in a first operating stage and when the first solar energy receiver 120 is in the second state, the concentrated solar power system 1000 is in a second operating stage. The first operating stage may be a start-up operating stage where thermal energy is transferred from the first heat exchange fluid to the second heat exchange fluid. The second operating stage may be a power generation stage where heat is transferred from the second heat exchange fluid to the thermal mass composition M and then from the thermal mass composition M to the working fluid. Further details of this process are outlined below.

The method may further comprise, during the startup operating stage of the concentrated solar power plant 1000, reflecting solar energy with the plurality of heliostats 400 onto the first solar energy receiver 120 to heat the first heat exchange fluid in the first receiver heat exchange tubes 122 of the first solar energy receiver 120. The heat exchange fluid may then flow through the first fluid flow loop 210. This step transfers thermal energy from the first heat exchange fluid flowing through the first fluid flow loop 210 to the second heat exchange fluid in the second fluid flow loop 140 during the start up operating stage of the concentrated solar power system 1000. In the embodiment exemplified in FIGS. 1A & 1B, the first fluid flow loop 210 forms part of the working fluid circuit 200. The first solar energy receiver 120 is in the first state during this startup operating stage.

During this step, the thermal energy from the first heat exchange fluid may be transferred from the first fluid flow 210 loop to the thermal mass composition M via the first heat exchange tubes 251. Thermal energy is then transferred from the thermal mass composition M to the second heat exchange fluid. This process changes the viscosity of the heat exchange fluid to allow it to flow through the second fluid flow loop 140. For instance, when the second heat exchange fluid is a salt, the salt may start the startup operation stage at a lower first viscosity (i.e. the salt is frozen) and then be heated by the first heat exchange fluid to a second viscosity so that it is in a molten state.

The method may further comprise, during the startup operating stage of the concentrated solar power plant 1000 prior to step a) and while the first solar energy receive 120 is in the first state, flowing the working fluid through the startup branch 230 of the working fluid flow circuit 200, the first heat exchange fluid being the working fluid. Upon the second working fluid being heated sufficiently with thermal energy from the working fluid flowing through the first fluid flow loop 210, performing step a) and reflecting solar energy with the plurality of heliostats 400 onto the second solar energy receiver 130 to further heat the second heat exchange fluid in second receiver heat exchange tubes 132 of the second solar energy receiver 130. The second heat exchange fluid is then flow through the second fluid flow loop 140 and the working fluid is flowed through the power generation fluid flow loop 245 of the working fluid flow circuit 200. The startup branch 230 is then isolated from the remainder of the working fluid circuit 200 to prevent flow for the working fluid through the startup branch 230. Thermal energy is then transferred from the second heat exchange fluid to the working fluid in the power generation fluid flow loop 245.

In some embodiments, the method step a) is continued until the second heat exchange fluid reaches an operating temperature within the second fluid flow loop 140. This operating temperature is a temperature above ambient temperature where the second heat exchange fluid is in a liquid or molten state. In embodiments where the second heat exchange fluid is molten salt, the operating temperature is the melting temperature of the molten salt. As discussed above the concentrated solar power system 1000 may comprise temperature sensors throughout the thermal energy storage vessel 300, and the second fluid flow loop 140 to measure the temperature of the second heat exchange fluid and thermal mass composition.

After the method step a), the concentrated solar power system 1000 may be in the second operating stage which may also be a power generation operating stage. During this power generation stage, the startup branch valves are closed so that the power generation flow loop 270 is formed with the first set of heat exchange tubes 151 and the power generation branch 240 which includes the electricity generating subsystem 220. The working fluid is then driven through the electricity generation subsystem 220 to generate electricity. In the exemplified embodiment, the working fluid is water so the electricity generation subsystem 220 performs a Rankine cycle to generate electricity. In other embodiments, a different power cycle with a different working fluid may be used such a Brayton cycle.

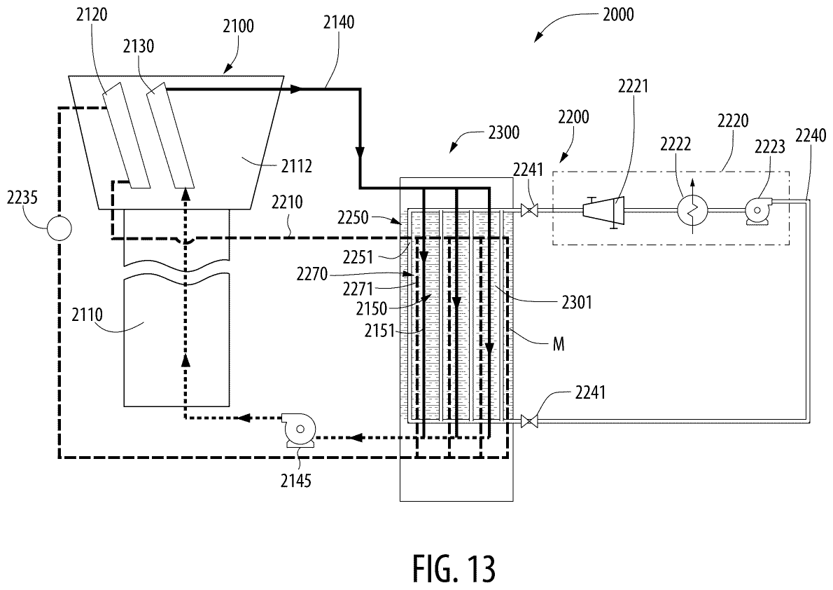

Referring to FIG. 13, an alternative concentrated solar power system 2000 will now be described. Unless otherwise noted, the subcomponents and subsystems of this alternative concentrated solar power system 2000 share the same subcomponents and subsystems of the concentrated solar power system 1000 but are referred using “2***” reference signs.

As shown in FIG. 13, a first solar energy receiver 2120 is deployed in the first state. In this embodiment, a first fluid flow loop 2210 is entirely separate from a working fluid circuit 2200. Further, a third set of heat exchange tubes 2271 are at least partially embedded within the thermal mass composition M of a thermal energy storage vessel 2300 and form part of the first fluid flow loop 2210. In such an embodiment the fluid heat exchange fluid is different from the working fluid. The first heat exchange fluid still has a lower viscosity than the second heat exchange fluid at ambient temperature. In the exemplified embodiment, the first heat exchange fluid is a synthetic oil, the second working fluid is molten salt, and the working fluid is steam. Thus, at ambient temperature, the synthetic oil is in liquid form, and the molten salt is “frozen” giving it a higher viscosity than the synthetic oil.

A method of operating the concentrated solar power system 2000 will now be described. The method of operating the concentrated solar power system 2000 is similar to the method of operating of the method of operating of the concentrated solar power system 1000 except that the working fluid is not the same as the first heat exchange fluid. The method still includes a step a) for moving the first solar energy receiver 2120 relative to a tower 2110 to alter the first solar energy receiver 2120 from the first state to the second state. In the exemplified embodiment of the concentrated solar power system 2000, prior to step a) the concentrated solar power system 2000 is in a startup operating stage the first heat exchange fluid is heated with thermal energy harnessed by the first solar energy receiver 2120. The thermal energy is then transmitted from the first heat exchange fluid to the thermal mass composition M of a thermal energy storage vessel 2300 by flowing the first heat exchange fluid via the first fluid flow loop 2210 from the first solar energy receiver 2120 to the third set of heat exchange tubes 2271. The thermal energy is then transmitted from the thermal mass composition M to the second heat exchange fluid via a second set of heat exchange tubes 2151. The concentrated solar power system 2000 may then perform some or all of the method steps that are performed by the concentrated solar power system 1000.

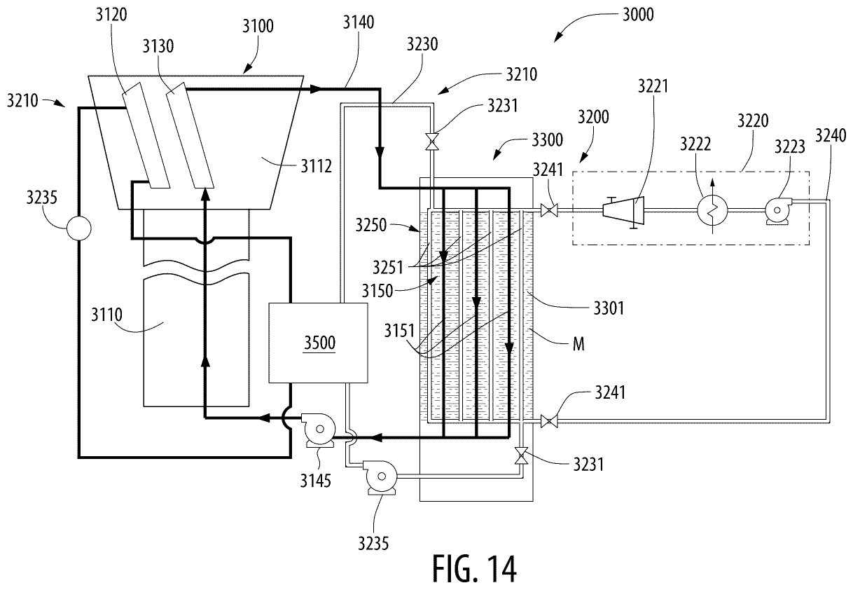

Referring to FIG. 14, a second alternative concentrated solar power system 3000 will now be described. Unless otherwise noted, the subcomponents and subsystems of the concentrated solar power system 3000 share the same subcomponents and subsystems of the concentrated solar power system 1000 and concentrated solar power system 2000 but are referred using “3***” reference signs.

As shown in FIG. 14, the concentrated solar power system 3000, a first fluid flow loop 3210 is entirely separated from the working fluid circuit 3200. In contrast to the concentrated solar power system 2000, the concentrated solar power system 3000 comprises a startup heat exchanger 3500. The startup heat exchanger 3500 is part of a startup branch 3230 of the working fluid circuit 3200 and the first fluid flow loop 3210. The startup heat exchanger 3500 is configured to transmit thermal energy from the first heat exchange fluid in the first fluid flow loop 3210 to the working fluid in the startup branch 3230.

As a non-limiting example, the startup heat exchanger 3500 may be a shell and tube type heat exchanger well known in the art would includes an outer shell that may housing a portion of the first fluid flow loop 3210 and the inner shell that may house a portion of the startup branch 3230 of the working fluid circuit 3200. Of course, in alterative embodiments this order may be reversed, and the outer shell may house the portion of the startup branch 3230 of the working fluid circuit 3200 and the inner shell may house the portion of the first fluid flow loop 3210. Other types of cross-flow heat exchanges may be used for the startup heat exchanger 3500 as well.

A method of operating the concentrated solar power system 3000 will now be described. The method of operating the concentrated solar power system 3000 is similar to the method of operating of the method of operating of the concentrated solar power system 1000 except that the working fluid is not the same as the first heat exchange fluid. The method still includes a step a) for moving a first solar receiver 3120 relative to a tower 3110 from a first state to a second state. In the exemplified embodiment, the first heat exchange fluid is heated with reflected solar energy in the first solar energy receiver 3120. The first heat exchange fluid then yields its thermal energy to working fluid in the startup heat exchanger 3500 to produce steam. The steam is then flowed through a thermal energy storage vessel 3300 to add energy to the second heat exchange fluid which is in a second fluid flow loop 2140. This added thermal energy decrease the viscosity of the second heat exchange fluid. In the exemplified embodiment, the first heat exchange fluid is a synthetic heat transfer oil, the second heat exchange fluid is a molten salt, and the working fluid is water.

In this embodiment, the first heat transfer fluid never flows through the never flows through the thermal energy storage vessel 3300 and is fluidly isolated from the molten salt circulated through the first closed flow loop. A startup oil pump 3555 circulates the first heat exchange fluid through the first fluid flow loop 3210.

### EXEMPLARY CLAIM SET

The following is a non-limiting list of example claims to several embodiments of the present invention.

Exemplary claim 1: A concentrated solar power system comprising: a solar energy collection subsystem comprising:

a tower extending along a tower axis; and a first solar energy receiver movably mounted to the tower to be alterable between a first state and a second state while remaining mounted to the tower, the first solar energy receiver containing a first heat exchange fluid.

Exemplary claim 2: The concentrated solar power system according to exemplary claim 1 further comprising: a second solar energy receiver mounted to the tower at a target location, the second solar energy receiver containing a second heat exchange fluid; and a plurality of heliostats configured to receive solar energy and reflect the solar energy to the target location.

Exemplary claim 3: The concentrated solar power system according to exemplary claim 2 wherein the first state is an operating state in which the first solar energy receiver is positioned to receive at least a portion of the reflected solar energy from the plurality of heliostats to heat the first heat exchange fluid in the first solar energy receiver and at least partially block the reflected solar energy from reaching the second solar energy receiver.

Exemplary claim 4: The concentrated solar power system according to exemplary claim 3 wherein the second state is a standby state in which the first solar energy receiver is positioned so as to not block the reflected solar energy from reaching the second solar energy receiver or blocks a lesser amount of the reflected solar energy from reaching the second solar energy receiver.

Exemplary claim 5: The concentrated solar power system according to any one of exemplary claims 2 to 4 wherein, when the first solar energy receiver is in the second state, the second solar energy receives the reflected solar energy to heat the second heat exchange fluid in the second solar energy receiver.

Exemplary claim 6: The concentrated solar power system according to any one of claims 2 to 5 wherein, at ambient conditions, the first heat exchange fluid has a first viscosity and the second heat exchange fluid has a second viscosity, the second viscosity being greater than the first viscosity.

Exemplary claim 7: The concentrated solar power system according to any one of exemplary claims 2 to 6 further comprising: a first fluid flow loop configured to circulate the first heat exchange fluid therethrough, the first solar energy receiver being part of the first fluid flow loop; a second fluid flow loop configured to circulate the second heat exchange fluid therethrough, the second solar energy receiver being part of the second fluid flow loop; and wherein the concentrated solar power system is configured to transfer heat from the first heat exchange fluid in the first fluid flow loop to the second heat exchange fluid in the second fluid flow loop during a startup operating stage of the concentrated solar power system, the first solar energy receiver being in the first state during the startup operating stage.

Exemplary claim 8: The concentrated solar power system according to exemplary claim 7 further comprising: an electricity generation subsystem configured to convert thermal energy from a working fluid into electricity; a working fluid flow circuit configured to circulate the working fluid, the electricity generation subsystem being part of the working fluid flow circuit.

Exemplary claim 9: The concentrated solar power system according to exemplary claim 8 further comprising: the first fluid flow loop being part of the working fluid flow circuit, the first heat exchange fluid being the working fluid.

Exemplary claim 10: The concentrated solar power system according to exemplary claim 9 further comprising: the first fluid flow loop comprising a startup branch, the first solar energy receiver being part of the startup branch; the working fluid flow circuit comprising a power generation branch, the electricity generation subsystem being a part of the power generation branch; the working fluid flow circuit configured to isolate the startup branch from a remainder of the working fluid circuit to prevent flow of the working fluid through the startup branch during a power generation operating stage of the concentrated solar power system, the first solar energy receiver being in the second state during the power generation operating stage; and wherein the working fluid flow circuit comprises a power generation fluid flow loop during the power generation operating stage, the power generation subsystem being part of the power generation fluid flow loop.

Exemplary claim 11: The concentrated solar power system according to exemplary claim 10 further comprising: a thermal energy storage vessel comprising containing a thermal mass composition operable to store thermal energy; a first set of heat exchange tubes at least partially embedded in the thermal mass composition, the first set of heat exchange tubes being part of the working fluid flow circuit; and a second set of heat exchange tubes at least partially embedded in the thermal mass composition, the second set of heat exchange tubes being part of the second fluid flow loop.

Exemplary claim 12: The concentrated solar power system according to exemplary claim 11 further comprising: the first set of heat exchange tubes being part of both the first fluid flow loop and the power generation fluid flow loop; and the concentrated solar power system configured so that during the startup operating stage, the working fluid is heated by the first solar energy receiver, the thermal mass composition is heated by the working fluid, and the thermal mass composition heats the second heat exchange fluid; and wherein the concentrated solar power system is configured so that during the power generation operating stage, the second heat exchange fluid is heated by the second solar energy receiver, the second heat exchange fluid heats the thermal mass composition, the thermal mass composition heats the working fluid.

Exemplary claim 13: The concentrated solar power system according to exemplary claim 8 further comprising: a working fluid flow circuit comprising a power generation branch and a startup branch, the electric generation subsystem being a part of the power generation branch; and a startup heat exchanger being part of the startup branch and the first fluid flow loop, the startup heat exchanger configured to transmit thermal energy from the first heat exchange fluid in the first fluid flow loop to the working fluid in the startup branch.

Exemplary claim 14: The concentrated solar power system according to exemplary claim 13 further comprising: a thermal energy storage vessel containing a thermal mass composition operable to store thermal energy; a first set of heat exchange tubes at least partially embedded in the thermal mass composition, the first set of heat exchange tubes being part of the working fluid flow circuit; and a second set of heat exchange tubes at least partially embedded in the thermal mass composition, the second set of heat exchange tubes being part of the second fluid flow loop.

Exemplary claim 15: The concentrated solar power system according to exemplary claim 14 further comprising: the working fluid flow circuit comprising a startup fluid flow loop, the startup branch and the first set of heat exchange tubes being part of the startup fluid flow loop; and the working fluid flow circuit configured to flow the working fluid through the startup fluid flow loop during the startup operating stage of the concentrated solar power system.

Exemplary claim 16: The concentrated solar power system according to exemplary claim 15 further comprising: the working fluid flow circuit configured to flow the working fluid through a power generation fluid flow loop during a power generation operating stage of the concentrated solar power, the power generation subsystem and the first set of heat exchange tubes being part of the power generation fluid flow loop; and the working fluid flow circuit configured to isolate the startup branch from a remainder of the working fluid circuit to prevent flow of the working fluid through the startup branch during an power generation operating stage of the concentrated solar power system, the first solar energy receiver being in the second state during the power generation operating stage.

Exemplary claim 17: The concentrated solar power system according to exemplary claim 16 further comprising: the concentrated solar power system configured to, during the startup operating stage: (i) heat the first heat exchange fluid in the first fluid flow loop via the first solar energy receiver; (ii) heat the working fluid in the startup branch by transferring thermal energy from the first heat exchange fluid to the working fluid via the startup heat exchanger; (iii) heat the thermal mass composition by transferring thermal energy from the working fluid to the thermal mass composition via the first set of heat exchange tubes; and (iv) heat the second the second heat exchange fluid by transmitting thermal energy from the thermal mass composition to the second heat exchange fluid via the second heat exchange tubes.

Exemplary claim 18: The concentrated solar power system according to exemplary claim 17 further comprising: the concentrated solar power system configured to, during the power generation operating stage: (i) heat the second heat exchange fluid via the second solar energy receiver; (ii) heat the thermal mass composition by transmitting thermal energy from the second heat exchange fluid to the thermal mass composition via the second heat exchange tubes; and (iii) heat the working fluid in the power generation fluid flow loop by transmitting thermal energy from the thermal mass composition to the working fluid via the first set of heat exchange tubes.

Exemplary claim 19: The concentrated solar power system according to any one of exemplary claims 1 to 18 wherein the first solar energy receiver is mounted to the tower to be pivotable between the first state and the second state about at least one pivot axis.

Exemplary claim 20: The concentrated solar power system according to exemplary claim 19 wherein the at least one pivot axis is substantially parallel to the tower axis.

Exemplary claim 21: The concentrated solar power system according to any one of exemplary claims 18 to 19 wherein the first solar energy receiver comprises a first sub-receiver and a second sub-receiver, the first sub-receiver mounted to the tower to be pivotable between a first pivot axis and the second sub-receiver mounted to the tower to be pivotable about a second pivot axis, the first and second axes being parallel to one another, and a second receiver located between the first and second pivot axes.

Exemplary claim 22: The concentrated solar power system according to any one of exemplary claims 1 to 18 wherein the first solar energy receiver is translatable along a circumferential path between the first and second states.

Exemplary claim 23: The concentrated solar power system according to any one of exemplary claims 1 to 18 wherein the first solar energy receiver is vertically translatable between the first and second states.

Exemplary claim 24: The concentrated solar power system according to any one of exemplary claims 1 to 23 wherein the first and second solar energy receivers are located at a same elevation on the tower when the first solar energy receiver is in both the first and second states.

Exemplary claim 25: A method of operating a concentrated solar power system comprising a solar energy collection subsystem having a tower and a first solar energy receiver movably mounted to the tower, the method comprising: a) moving the first solar energy receiver relative to the tower to alter the first solar energy receiver from a first state to a second state, the first solar energy receiver comprising first receiver heat exchange tubes containing a first heat exchange fluid, the first solar energy receiver being part of a first fluid flow loop through which the first heat exchange fluid flows.

Exemplary claim 26: The method according to exemplary claim 25 wherein the first state is an operating state in which the first solar energy receiver is positioned to receive at least a portion of reflected solar energy from a plurality of heliostats to heat the first heat exchange fluid via the first receiver heat exchange tubes of the first solar energy receiver and at least partially block the reflected solar energy from reaching a second solar energy receiver mounted to the tower; and wherein the second state is a standby state in which the first solar energy receiver is positioned so as to not block the reflected solar energy from reaching the second solar energy receiver or blocks a lesser amount of the reflected solar energy from reaching the second solar energy receiver, the second receiver being part of a second fluid flow loop through which the second heat exchange fluid flows.

Exemplary claim 27: The method according to any one of exemplary claims 25 to 26 wherein, at ambient conditions, the first heat exchange fluid has a first viscosity and the second heat exchange fluid has a second viscosity, the second viscosity being greater than the first viscosity.

Exemplary claim 28: The method according to exemplary claim 27 wherein the solar collection subsystem further comprises a second solar energy receiver mounted to the tower, the second solar energy receiver being part of a second fluid loop containing a second heat exchange fluid.

Exemplary claim 29: The method according to exemplary claim 28 further comprising, during a startup operating stage of the concentrated solar power plant prior to step a): reflecting solar energy with a plurality of heliostats onto the first solar energy receiver to heat the first heat exchange fluid in the first receiver heat exchange tubes of the first solar energy receiver; flowing the first heat exchange fluid through the first fluid flow loop; and transferring thermal energy from the first heat exchange fluid flowing through the first fluid flow loop to the second heat exchange fluid in the second fluid flow loop during a startup operating stage of the concentrated solar power system, the first solar energy receiver being in the first state during the startup operating stage.

Exemplary claim 30: The method according to exemplary claim 29 wherein the concentrated solar power plant further comprises an electricity generation subsystem configured to convert thermal energy from a working fluid into electricity and a working fluid flow circuit configured to circulate the working fluid, the electricity generation subsystem being part of the working fluid flow circuit, the first fluid flow loop being part of the working fluid flow circuit, the first heat exchange fluid being the working fluid, the method further comprising: during the startup operating stage of the concentrated solar power plant prior to step a) while the first solar energy receiver is in the first state, flowing the working fluid through a startup branch of the working fluid flow circuit, the first solar energy receiver being part of the startup branch and the startup branch being part of the first fluid flow loop; upon the second heat exchange fluid being heated sufficiently with thermal energy from the working fluid flowing through the first fluid flow loop, performing step a) and reflecting solar energy with the plurality of heliostats onto the second solar energy receiver to further heat the second heat exchange fluid in second receiver heat exchange tubes of the second solar energy receiver; flowing the second heat exchange fluid through the second fluid flow loop; flowing the working fluid through a power generation fluid flow loop of the working fluid flow circuit, the electricity generation subsystem being part of the power generation fluid flow loop; isolating the startup branch from a remainder of the working fluid circuit to prevent flow of the working fluid through the startup branch; and transferring thermal energy from the second heat exchange fluid to the working fluid in the power generation fluid flow loop.

Exemplary claim 31: The method according to exemplary claim 29 wherein the concentrated solar power plant further comprises an electricity generation subsystem configured to convert thermal energy from a working fluid into electricity and a working fluid flow circuit configured to circulate the working fluid, the electricity generation subsystem being part of the working fluid flow circuit, the working fluid flow circuit comprising a power generation branch and a startup branch, the electric generation subsystem being a part of the power generation branch, the method further comprising: during the startup operating stage of the concentrated solar power plant prior to step a) while the first solar energy receiver is in the first state, flowing the working fluid through the startup branch of the working fluid flow circuit; transmitting thermal energy from the first heat exchange fluid in the first fluid flow loop into the working fluid flowing through the startup branch; upon the second heat exchange fluid being heated sufficiently with thermal energy from the working fluid flowing through the first fluid flow loop, performing step a) and reflecting solar energy with the plurality of heliostats onto the second solar energy receiver to further heat the second heat exchange fluid in second receiver heat exchange tubes of the second solar energy receiver; flowing the second heat exchange fluid through the second fluid flow loop; flowing the working fluid through a power generation fluid flow loop of the working fluid flow circuit, the electricity generation subsystem being part of the power generation fluid flow loop; isolating the startup branch from a remainder of the working fluid circuit to prevent flow of the working fluid through the startup branch; and transferring thermal energy from the second heat exchange fluid to the working fluid in the power generation fluid flow loop.

Exemplary claim 32: A concentrated solar power system comprising: a solar energy collection subsystem comprising a first solar energy receiver; a thermal energy storage vessel containing a thermal mass composition operable to store thermal energy; an electricity generation subsystem configured to convert thermal energy from a working fluid into electricity; a working fluid flow circuit containing the working fluid and configured to circulate the working fluid therethrough, the working fluid flow circuit comprising, in operable fluid cooperation, a first branch, a second branch comprising the electricity generation subsystem, and a first set of heat exchange tubes at least partially embedded in the thermal mass composition, the working fluid flow circuit configured to be altered so that; during a first operating stage of the concentrated solar power system, the first branch and the first set of heat exchange tubes collectively form an auxiliary fluid flow loop configured to receive thermal energy in the working fluid from the first solar energy receiver and transmit thermal energy from the working fluid to the thermal mass composition through the first set of heat exchange tubes; and during a second operating stage of the concentrated solar power system, the second branch and the first set of heat exchange tubes collectively form a power generation fluid flow loop, the power generation fluid flow loop configured to receive thermal energy in the working fluid from the thermal mass composition through the first set of heat exchange tubes and transmit thermal energy from the working fluid to the electricity generation subsystem to generate the electricity.

Exemplary claim 33: The concentrated solar power system according to exemplary claim 32 wherein the working fluid flow circuit is configured to isolate the first branch from a remainder of the working fluid circuit to prevent flow of the working fluid through the first branch during the second operating stage of the concentrated solar power system.

Exemplary claim 34: The concentrated solar power system according to exemplary claim 33 wherein the working fluid flow circuit comprises one or more valves configured to isolate the first branch from the remainder of the working fluid circuit.

Exemplary claim 35: The concentrated solar power system according to any one of exemplary claims 32 to 34 wherein the working fluid is water and the working fluid flowing through the power generation fluid flow loop undergoes the Rankine cycle.

Exemplary claim 36: The concentrated solar power system according to any one of claims 32 to 35 wherein the working fluid flow circuit is configured to flow the working fluid through both the auxiliary fluid flow loop and the power generation fluid flow loop during the first operating stage of the concentrated solar power system.

Exemplary claim 37: The concentrated solar power system according to any one of exemplary claims 32 to 35 wherein the working fluid flow circuit is configured to isolate the second branch from a remainder of the working fluid circuit to prevent flow of the working fluid through the second branch during the first operating stage of the concentrated solar power system.

Exemplary claim 38: The concentrated solar power system according to exemplary claim 37 wherein the working fluid flow circuit comprises one or more valves configured to isolate the second branch from the remainder of the working fluid circuit.

Exemplary claim 39: The concentrated solar power system according to any one of exemplary claims 32 to 38 further comprising: the solar energy collection subsystem comprising a second solar energy receiver; and a second fluid flow loop comprising the second solar energy receiver and a second set of heat exchange tubes at least partially embedded in the in the thermal mass composition, the second fluid flow loop containing a second heat exchange fluid.

Exemplary claim 40: The concentrated solar power system according to exemplary claim 39 wherein the concentrated solar power system is configured to transmit thermal energy that was delivered to the thermal mass composition by the working fluid to the second heat exchange fluid though the second set of heat exchange tubes during the first operating stage.

Exemplary claim 41: The concentrated solar power system according to any one of exemplary claims 39 to 40 wherein the concentrated solar power system is configured to receive thermal energy in the second heat exchange fluid from the second solar energy receiver and transmit thermal energy from the second heat exchange fluid to the thermal mass composition through the second set of heat exchange tubes during the second operating stage.

Exemplary claim 42: The concentrated solar power system according to any one of exemplary claims 32 to 41 wherein the first solar energy receiver forms a part of the auxiliary fluid flow loop, the working fluid flowing through first receiver heat exchange tubes of the first solar energy receiver.

Exemplary claim 43: The concentrated solar power system according to any one of exemplary claims 32 to 41 further comprising: a first fluid flow loop comprising the first solar energy receiver, the first fluid loop containing a first heat exchange fluid and configured to flow the first heat exchange fluid through the first fluid flow loop; and a heat exchanger, the heat exchanger being part of the first branch of the auxiliary fluid flow loop and the first fluid flow loop, the heat exchanger configured to transmit thermal energy from the first heat exchange fluid in the first fluid flow loop to the working fluid in the first branch during the first operating stage.

Exemplary claim 44: The concentrated solar power system according to exemplary claim 43 wherein, at ambient conditions, the first heat exchange fluid has a first viscosity and the second heat exchange fluid has a second viscosity, the second viscosity being greater than the first viscosity.

Exemplary claim 45: The concentrated solar power system according to any one of exemplary claims 39 to 41 wherein, at ambient conditions, the working fluid has a first viscosity and the second heat exchange fluid has a second viscosity, the second viscosity being greater than the first viscosity.

Exemplary claim 46: The concentrated solar power system according to any one of exemplary claims 32 to 45 wherein the solar energy collection subsystem further comprises a plurality of heliostats configured to receive solar energy and reflect the solar energy onto the first solar energy receiver, and optionally onto the second solar energy receiver.

Exemplary claim 47: The concentrated solar power system according to any one of exemplary claims 32 to 46 wherein the first operating stage is a startup operating stage and the second operating stage is a power generation operating stage.

Exemplary claim 48: A concentrated solar power system comprising: a solar energy collection subsystem comprising a first solar energy receiver and second solar energy receiver; a thermal energy storage vessel containing a thermal mass composition operable to store thermal energy; a first fluid flow loop comprising the first solar energy receiver and containing a first heat exchange fluid; a second fluid flow loop comprising the second solar energy receiver and containing a second heat exchange fluid; wherein, during a first operating stage of the concentrated solar power system, the concentrated solar power system is configured to: (i) transmit thermal energy into the first heat exchange fluid via the first solar energy receiver; (ii) transmit thermal energy from the first heat exchange fluid to the thermal mass composition, and (iii) transmit thermal energy from the thermal mass composition to the second heat exchange fluid; and wherein, at ambient conditions, the first heat exchange fluid has a first viscosity and the second heat exchange fluid has a second viscosity, the second viscosity being greater than the first viscosity.

Exemplary claim 49: The concentrated solar power system according to exemplary claim 48 further comprising: an electricity generation subsystem configured to convert thermal energy from a working fluid into electricity; a power generation fluid flow loop comprising the electricity generation subsystem, the power generation fluid flow loop containing the working fluid and configured to flow the working fluid through the power generation loop; and wherein, during a second operating stage of the concentrated solar power system, the concentrated solar power system is configured to: (i) transmit thermal energy from the second heat exchange fluid to the thermal mass composition; and (ii) transmit thermal energy from the thermal mass composition to the working fluid flowing through the power generation fluid flow loop.

Exemplary claim 50: The concentrated solar power system according to any one of exemplary claims 48 to 49 wherein the first heat exchange fluid is an oil, the second heat exchange fluid is a molten salt, and the working fluid is water.

Exemplary claim 51: A method of operating a concentrated solar power system comprising a solar energy collection subsystem comprising a first solar energy receiver, a thermal energy storage vessel containing a thermal mass composition operable to store thermal energy, an electricity generation subsystem configured to convert thermal energy from a working fluid into electricity, the method comprising: during a first operating stage of the concentrated solar power system: heating the working fluid with thermal energy harnessed by the first solar energy receiver; and transmitting thermal energy from the working fluid to the thermal mass composition; during a second operating stage of the concentrated solar power system: transmitting thermal energy from the thermal mass composition into the working fluid; and generating electricity utilizing thermal energy from the working fluid with the electricity generation subsystem.

Exemplary claim 52: The method according to exemplary claim 51 wherein the solar energy collection subsystem further comprises a second solar energy receiver that is part of a second fluid flow loop containing a second heat exchange fluid; and wherein step a) further comprises transmitting thermal energy from the thermal mass composition to the second heat exchange fluid during the first operating stage.

Exemplary claim 53: The method according to exemplary claim 52 wherein step a) is continued until the second heat exchange fluid reaches an operating temperature.

Exemplary claim 54: The method according to any one of exemplary claims 51 to 53 wherein the first operating stage is a startup operating stage and the second operating stage is a power generation operating stage.

Exemplary claim 55: A method of operating a concentrated solar power system comprising a solar energy collection subsystem comprising a first solar energy receiver and second solar energy receiver, a thermal energy storage vessel containing a thermal mass composition operable to store thermal energy, an electricity generation subsystem configured to convert thermal energy from a working fluid into electricity, a first fluid flow loop comprising the first solar energy receiver and containing a first heat exchange fluid, a second fluid flow loop comprising the second solar energy receiver and containing a second heat exchange fluid, the method comprising: during a first operating stage of the concentrated solar power system: heating the first heat exchange fluid with thermal energy harnessed by the first solar energy receiver; transmitting thermal energy from the first heat exchange fluid to the thermal mass composition; and transmitting thermal energy from the thermal mass composition to the second heat exchange fluid; and wherein, at ambient conditions, the first heat exchange fluid has a first viscosity and the second heat exchange fluid has a second viscosity, the second viscosity being greater than the first viscosity.

The method according to exemplary claim 55 wherein step a) is continued until the second heat exchange fluid reaches an operating temperature.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

What is claimed is:

1. A concentrated solar power system comprising:
a solar energy collection subsystem comprising:
a tower extending along a tower axis; and
a first solar energy receiver movably mounted to the tower to be alterable between a first state and a second state while remaining mounted to the tower, the first solar energy receiver containing a first heat exchange fluid.

2. The concentrated solar power system according to claim 1 further comprising:
a second solar energy receiver mounted to the tower at a target location, the second solar energy receiver containing a second heat exchange fluid; and
a plurality of heliostats configured to receive solar energy and reflect the solar energy to the target location.

3. The concentrated solar power system according to claim 2 wherein the first state is an operating state in which the first solar energy receiver is positioned to receive at least a portion of the reflected solar energy from the plurality of heliostats to heat the first heat exchange fluid in the first solar energy receiver and at least partially block the reflected solar energy from reaching the second solar energy receiver.

4. The concentrated solar power system according to claim 3 wherein the second state is a standby state in which the first solar energy receiver is positioned so as to not block the reflected solar energy from reaching the second solar energy receiver or blocks a lesser amount of the reflected solar energy from reaching the second solar energy receiver.

5. The concentrated solar power system according to claim 2 wherein, when the first solar energy receiver is in the second state, the second solar energy receives the reflected solar energy to heat the second heat exchange fluid in the second solar energy receiver.

6. The concentrated solar power system according to claim 2 wherein, at ambient conditions, the first heat exchange fluid has a first viscosity and the second heat exchange fluid has a second viscosity, the second viscosity being greater than the first viscosity.

7. The concentrated solar power system according to claim 2 further comprising:
a first fluid flow loop configured to circulate the first heat exchange fluid therethrough, the first solar energy receiver being part of the first fluid flow loop;
a second fluid flow loop configured to circulate the second heat exchange fluid therethrough, the second solar energy receiver being part of the second fluid flow loop; and
wherein the concentrated solar power system is configured to transfer heat from the first heat exchange fluid in the first fluid flow loop to the second heat exchange fluid in the second fluid flow loop during a startup operating stage of the concentrated solar power system, the first solar energy receiver being in the first state during the startup operating stage.

8. The concentrated solar power system according to claim 7 further comprising:
an electricity generation subsystem configured to convert thermal energy from a working fluid into electricity;
a working fluid flow circuit configured to circulate the working fluid, the electricity generation subsystem being part of the working fluid flow circuit.

9. The concentrated solar power system according to claim 8 further comprising:
the first fluid flow loop being part of the working fluid flow circuit, the first heat exchange fluid being the working fluid.

10. The concentrated solar power system according to claim 9 further comprising:
the first fluid flow loop comprising a startup branch, the first solar energy receiver being part of the startup branch;
the working fluid flow circuit comprising a power generation branch, the electricity generation subsystem being a part of the power generation branch;
the working fluid flow circuit configured to isolate the startup branch from a remainder of the working fluid circuit to prevent flow of the working fluid through the startup branch during a power generation operating stage of the concentrated solar power system, the first solar energy receiver being in the second state during the power generation operating stage; and
wherein the working fluid flow circuit comprises a power generation fluid flow loop during the power generation operating stage, the power generation subsystem being part of the power generation fluid flow loop.

11. The concentrated solar power system according to claim 10 further comprising:
a thermal energy storage vessel comprising containing a thermal mass composition operable to store thermal energy;
a first set of heat exchange tubes at least partially embedded in the thermal mass composition, the first set of heat exchange tubes being part of the working fluid flow circuit; and
a second set of heat exchange tubes at least partially embedded in the thermal mass composition, the second set of heat exchange tubes being part of the second fluid flow loop.

12. The concentrated solar power system according to claim 11 further comprising:
the first set of heat exchange tubes being part of both the first fluid flow loop and the power generation fluid flow loop; and
the concentrated solar power system configured so that during the startup operating stage, the working fluid is heated by the first solar energy receiver, the thermal mass composition is heated by the working fluid, and the thermal mass composition heats the second heat exchange fluid; and
wherein the concentrated solar power system is configured so that during the power generation operating stage, the second heat exchange fluid is heated by the second solar energy receiver, the second heat exchange fluid heats the thermal mass composition, the thermal mass composition heats the working fluid.

13.-18. (canceled)

19. The concentrated solar power system according to claim 1 wherein the first solar energy receiver is mounted to the tower to be pivotable between the first state and the second state about at least one pivot axis.

20. (canceled)

21. The concentrated solar power system according to claim 18 wherein the first solar energy receiver comprises a first sub-receiver and a second sub-receiver, the first sub-receiver mounted to the tower to be pivotable between a first pivot axis and the second sub-receiver mounted to the tower to be pivotable about a second pivot axis, the first and second axes being parallel to one another, and a second receiver located between the first and second pivot axes.

22.-24. (canceled)

25. A method of operating a concentrated solar power system comprising a solar energy collection subsystem having a tower and a first solar energy receiver movably mounted to the tower, the method comprising:
a) moving the first solar energy receiver relative to the tower to alter the first solar energy receiver from a first state to a second state, the first solar energy receiver comprising first receiver heat exchange tubes containing a first heat exchange fluid, the first solar energy receiver being part of a first fluid flow loop through which the first heat exchange fluid flows.

26. The method according to claim 25 wherein the first state is an operating state in which the first solar energy receiver is positioned to receive at least a portion of reflected solar energy from a plurality of heliostats to heat the first heat exchange fluid via the first receiver heat exchange tubes of the first solar energy receiver and at least partially block the reflected solar energy from reaching a second solar energy receiver mounted to the tower; and wherein the second state is a standby state in which the first solar energy receiver is positioned so as to not block the reflected solar energy from reaching the second solar energy receiver or blocks a lesser amount of the reflected solar energy from reaching the second solar energy receiver, the second receiver being part of a second fluid flow loop through which the second heat exchange fluid flows.

27. (canceled)

28. The method according to claim 25 wherein the solar collection subsystem further comprises a second solar energy receiver mounted to the tower, the second solar energy receiver being part of a second fluid loop containing a second heat exchange fluid.

29. The method according to claim 28 further comprising, during a startup operating stage of the concentrated solar power plant prior to step a):
reflecting solar energy with a plurality of heliostats onto the first solar energy receiver to heat the first heat exchange fluid in the first receiver heat exchange tubes of the first solar energy receiver;
flowing the first heat exchange fluid through the first fluid flow loop; and
transferring thermal energy from the first heat exchange fluid flowing through the first fluid flow loop to the second heat exchange fluid in the second fluid flow loop during a startup operating stage of the concentrated solar power system, the first solar energy receiver being in the first state during the startup operating stage.

30. The method according to claim 29 wherein the concentrated solar power plant further comprises an electricity generation subsystem configured to convert thermal energy from a working fluid into electricity and a working fluid flow circuit configured to circulate the working fluid, the electricity generation subsystem being part of the working fluid flow circuit, the first fluid flow loop being part of the working fluid flow circuit, the first heat exchange fluid being the working fluid, the method further comprising:
during the startup operating stage of the concentrated solar power plant prior to step a) while the first solar energy receiver is in the first state, flowing the working fluid through a startup branch of the working fluid flow circuit, the first solar energy receiver being part of the startup branch and the startup branch being part of the first fluid flow loop;
upon the second heat exchange fluid being heated sufficiently with thermal energy from the working fluid flowing through the first fluid flow loop, performing step a) and reflecting solar energy with the plurality of heliostats onto the second solar energy receiver to further heat the second heat exchange fluid in second receiver heat exchange tubes of the second solar energy receiver;
flowing the second heat exchange fluid through the second fluid flow loop;
flowing the working fluid through a power generation fluid flow loop of the working fluid flow circuit, the electricity generation subsystem being part of the power generation fluid flow loop;
isolating the startup branch from a remainder of the working fluid circuit to prevent flow of the working fluid through the startup branch; and
transferring thermal energy from the second heat exchange fluid to the working fluid in the power generation fluid flow loop.

31. (canceled)

32. A concentrated solar power system comprising:
a solar energy collection subsystem comprising a first solar energy receiver;
a thermal energy storage vessel containing a thermal mass composition operable to store thermal energy;
an electricity generation subsystem configured to convert thermal energy from a working fluid into electricity;
a working fluid flow circuit containing the working fluid and configured to circulate the working fluid therethrough, the working fluid flow circuit comprising, in operable fluid cooperation, a first branch, a second branch comprising the electricity generation subsystem, and a first set of heat exchange tubes at least partially embedded in the thermal mass composition, the working fluid flow circuit configured to be altered so that;
during a first operating stage of the concentrated solar power system, the first branch and the first set of heat exchange tubes collectively form an auxiliary fluid flow loop configured to receive thermal energy in the working fluid from the first solar energy receiver and transmit thermal energy from the working fluid to the thermal mass composition through the first set of heat exchange tubes; and
during a second operating stage of the concentrated solar power system,
the second branch and the first set of heat exchange tubes collectively form a power generation fluid flow loop, the power generation fluid flow loop configured to receive thermal energy in the working fluid from the thermal mass composition through the first set of heat exchange tubes and transmit thermal energy from the working fluid to the electricity generation subsystem to generate the electricity.

33. The concentrated solar power system according to claim 32 wherein the working fluid flow circuit is configured to isolate the first branch from a remainder of the working fluid circuit to prevent flow of the working fluid through the first branch during the second operating stage of the concentrated solar power system.

34.-56. (canceled)
